(19) United States
(12) Patent Application Publication
(10) Pub. No.: US 2018/0257918 A1
(43) Pub. Date: Sep. 13, 2018

(54) LIQUID CONTAINER FILL STAND

(71) Applicant: Robert C. Hedin, Hutchinson, MN (US)

(72) Inventor: Robert C. Hedin, Hutchinson, MN (US)

(21) Appl. No.: 15/913,601

(22) Filed: Mar. 6, 2018

Related U.S. Application Data
(60) Provisional application No. 62/601,074, filed on Mar. 10, 2017.

(51) Int. Cl. B67C 3/24; F21S 9/02; F21V 14/02; F21V 23/04

(52) U.S. Cl. CPC B67C 3/24; F21S 9/02; F21Y 2115/10; F21V 23/04; F21V 14/02

(57) ABSTRACT

Various aspects of the present disclosure are directed toward apparatuses, systems, and methods that include a device for holding a container during filling the container with a liquid. The device including a base having a planar surface for a container to be arranged thereon, a post extending perpendicular to the base. The device may also include brackets arranged along the post. The brackets are configured to interface and hold the container. In addition, the device may include a light arranged along the post and configured to illuminate a portion of the container.

### CROSS-REFERENCE TO RELATED APPLICATION

This application claims priority to Provisional Application No. 62/601,074, filed Mar. 10, 2017, which is herein incorporated by reference in its entirety.

### TECHNICAL FIELD

The present disclosure relates generally to apparatuses, systems, and methods for small batch or at-home production of alcoholic beverages for an amateur brewer or vintner. In particular, the present disclosure generally relates to apparatuses, systems, and methods that hold a single container or bottle during filling.

### BACKGROUND

Beverages that are frequently brewed at home, such as beer, wine, cider, mead, ginger ale, sake, and others may require multiple devices for containing fluids. Home brewing and wine making require a number of steps, which often include transitioning liquids between containers. In certain instances, the brewing or fermenting process includes multi-stage alternating between two fermentation containers or brewing tanks, which requires repetitive lifting.

After the brewing or fermentation process is completed, end use containers are filled from a larger storage tank, barrel, or container with a desired serving of the completed beverage. Amateur brewers or vintners typically manually fill these end use containers (e.g., wine bottles, 750 ml bottles, or other similar bottles). The liquid may be poured or siphoned into the end container and then capped or corked for storage and serving. Due to the use of a large and/or heavy storage tanks or containers, filling the end use containers can be difficult and may include, for example, lifting the storage tank or container with one arm and holding the end use container with the other. Thus, there is a need for a device that assists amateur brewers or vintners in filling end use containers.

### SUMMARY

Various aspects of the present disclosure are directed toward a device for holding a container during filling the container with a liquid. The device can include a base having a planar surface for a base of the container to be arranged thereon and a post extending perpendicular to the base. In addition, the device includes a first bracket arranged at a first location along the post and a second bracket arranged at a second location along the post with at least one of the first bracket and the second bracket being configured to interface with and hold the container and during filling of the container. Further, the device may also include a light arranged at a third location along the post and configured to illuminate a portion of the container to assist in determining a filling end point for the liquid within the container.

Various aspects of the present disclosure are directed toward beverage container stabilizing device for disadvantaged individuals. The device may include a base having a first aperture and a stabilizing member having a first end, a second end, and a length, the first end secured to the base in the first aperture. The device may also include a plurality of brackets spaced along the length of the stabilizing member. The plurality of brackets are configured to receive at least a portion of the beverage container. In addition, the device may include a light coupled to the second end of the stabilizing member for illuminating an interior at the beverage container.

Various aspects of the present disclosure are directed toward a method of using a beverage container stabilization device. The method includes positioning a beverage container on a base of the device such that the beverage container is received by at least one bracket of the device. The method also includes switching on a light associated with the device to illuminate an interior of the beverage container. In addition, the method includes filling the beverage container to a desired level as illuminated by the light, switching off the light, and removing the beverage container from the base.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is an example device for holding a container during filling the container with a liquid, in accordance with an embodiment; and

FIG. 2 is another example device for holding a container during filling the container with a liquid, in accordance with an embodiment.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

Various aspects of the present disclosure are directed toward apparatuses, systems, and methods having a device for holding and stabilizing a container during filling of the container with a liquid. In particular, the device may be used in association with the home brewing or home fermenting of beverages such as beer, wine, cider, and other types of beverages. Home brewing or home fermenting of beverages may involve multiple fermentation steps, which often require repeatedly transferring the beverage between large tanks or containers.

These large containers are also known as carboys. In some instances, multiple carboys could be used, for example, during primary and secondary fermentation. In some embodiments, the carboy (or similar large container) is a glass or plastic vessel used in fermenting beverages. The carboy is a rigid container with a typical capacity of 5 to 15 gallons (19 to 57 liters). Carboys are used for transporting fluids such as water, malt, chemicals, etc., some of which may be especially dense, viscous, and/or heavy. In some instances, a home brewer may have multiple carboys for brewing various wines or beers, all of which may require storage on shelves, in closets, or generally away from the fermentation site. Transfer, movement and general handling of these relatively large and/or heavy carboys whether empty or filled with wort can present logistical problems.

End use containers (e.g., wine bottles, 750 milliliter bottles, and similar other containers) are filled from the carboys for serving or drinking of the beverage. In home brewing or home fermenting, the end use containers are often filled by hand one at a time, as opposed to by machines on an assembly line. As a result, the amateur brewer or vintner must often transfer liquid from a large container to a small container numerous times.

In addition, the handling of the end use containers is important to avoid oxidization and/or contamination of the final product. For example, siphoning wine from a large container to a smaller container results in air exposure. This, in turn, presents an increased chance of oxidization and/or contamination, which may taint the wine or adversely alter the final product. Oxidization and/or contamination can similarly taint a batch of beer.

The apparatuses, systems, and methods discussed herein include a device for holding and stabilizing a container to ease the filling process and reduce the opportunity for spoiling and/or tainting of the liquid. The device for holding and stabilizing the container assists amateur brewers and vintners during a home brewing or fermenting process by stabilizing the end use containers, which may be filled one at a time. In addition, the device assists amateur brewers and vintners who are disadvantaged in one form or another (e.g., physically handicapped or elderly individuals). The device stabilizes the end use container so that amateur brewers and vintners can focus on transferring the liquid to the end use container without worrying about liquid spilling or the end use container shifting or falling. The device also includes a light arranged near a top portion of the end use container to allow the amateur brewers and vintners to view a stopping point when filling the bottle. Consistent with the above, the devices discussed herein are advantageous for amateur brewers and vintners by stabilizing end use containers during filling, maintaining a sanitary end use container, and assisting in viewing a stopping point for filling the end use container. Each of these advantages are provided by a cost efficient device, as discussed herein.

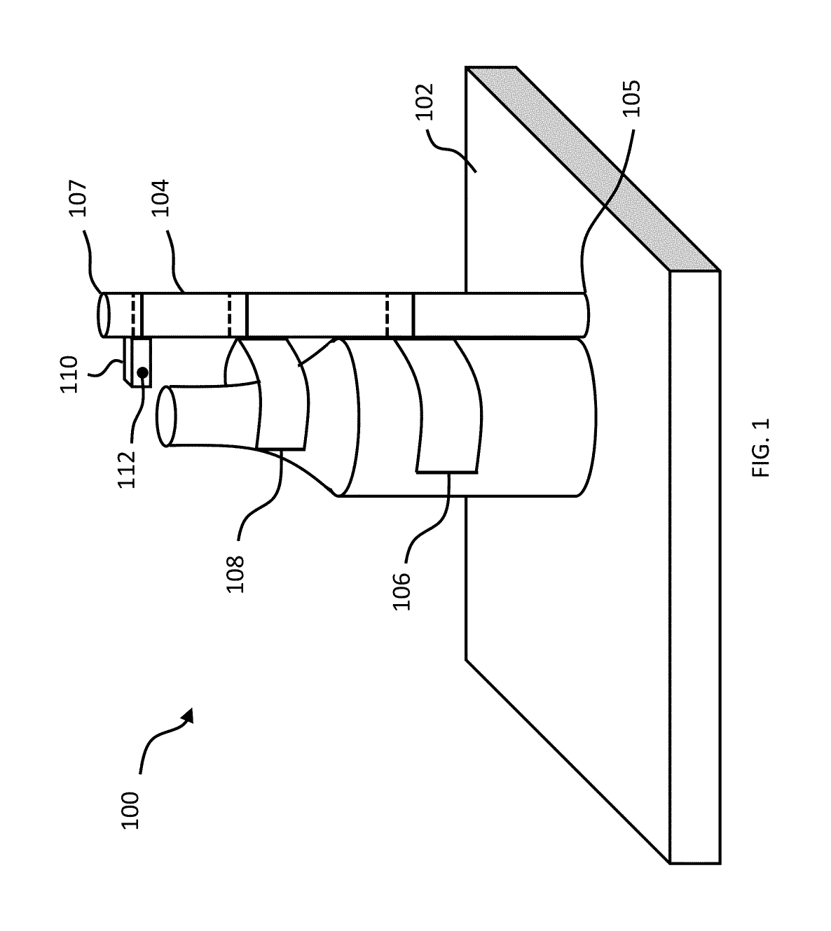

FIG. 1 is an example device 100 for holding and/or stabilizing a container during liquid filling, in accordance with an embodiment. As noted above, the device 100 may be particularly beneficial for amateur brewers and vintners filling one container at a time. In addition, the device 100 may be beneficial as a beverage container stabilization device for disadvantaged individuals.

In certain instances, the device 100 includes a base 102 having a planar surface for a base of the container to be arranged thereon. In some embodiments, the base 102 may be flat or substantially flat to prevent the container from shifting, tipping, and/or falling. In some embodiments, the base 102 may have a slight depression in the planar surface for receipt of the base of the container and to promote further stabilization of the container. In some embodiments, the base 102 includes a first aperture (not shown) configured to receive a stabilization member.

The stabilization member is oriented perpendicular to the base 102 and is removably received in the first aperture (e.g., for storage). In some embodiments, the stabilization member is a post 104, as shown in FIG. 1. However, the stabilization member can be any of a variety of configurations capable of bracing, steadying, or otherwise maintaining the container in an upright position. For example, the stabilization member may also be a dowel, a rod, a shaft, a plank, a beam, or other length of material capable of providing support.

The post 104 includes a first end 105 and a second 107 forming a length. In some embodiments, the post 104 is a suitable length to stabilize the container. For example, the length of the post 104 can be approximately equal to the height of a wine bottle, a beer bottle, a growler, or other end use container as desired. In some embodiments, the post 104 has a length from about 5 inches to about 15 inches, though other lengths are also possible.

The device 100 also includes a plurality of brackets spaced along the length of the post 104. In some embodiments, the device 100 includes a first bracket 106 arranged at a first location along the post 104 and a second bracket 108 arranged at a second location along the post 104. Though described herein as including two brackets (or bottle collars), it should be understood that the device 100 can include additional brackets as desired. For example, in some embodiments, the device 100 could include a third bracket, a fourth bracket, or any number of additional brackets as desired to retain various portions and/or sizes of containers.

In some embodiments, at least one of the first bracket 106 and the second bracket 108 is configured to interface with and/or hold the container during liquid filling. In some embodiments, the first bracket 106 is sized larger than the second bracket 108. For example, the first bracket 106 may be configured to interface with a portion of a wine bottle and the second bracket 108 may be configured to interface with a portion of a beer bottle. In another example, the first bracket 106 may be configured to interface with a body portion of a wine bottle and the second bracket 108 may be configured to interface with a neck portion of a wine bottle.

In some embodiments, the first and second brackets 106, 108 may be circular or semi-circular collars capable of receiving the container therein. For example, the brackets may reach around the entire circumference or a portion of the circumference of the container. In some embodiments, the brackets are configured to receive and retain the container via a friction fit. For example, the brackets may be shaped slightly smaller than the container such that the container fits firmly and/or snuggly within the brackets.

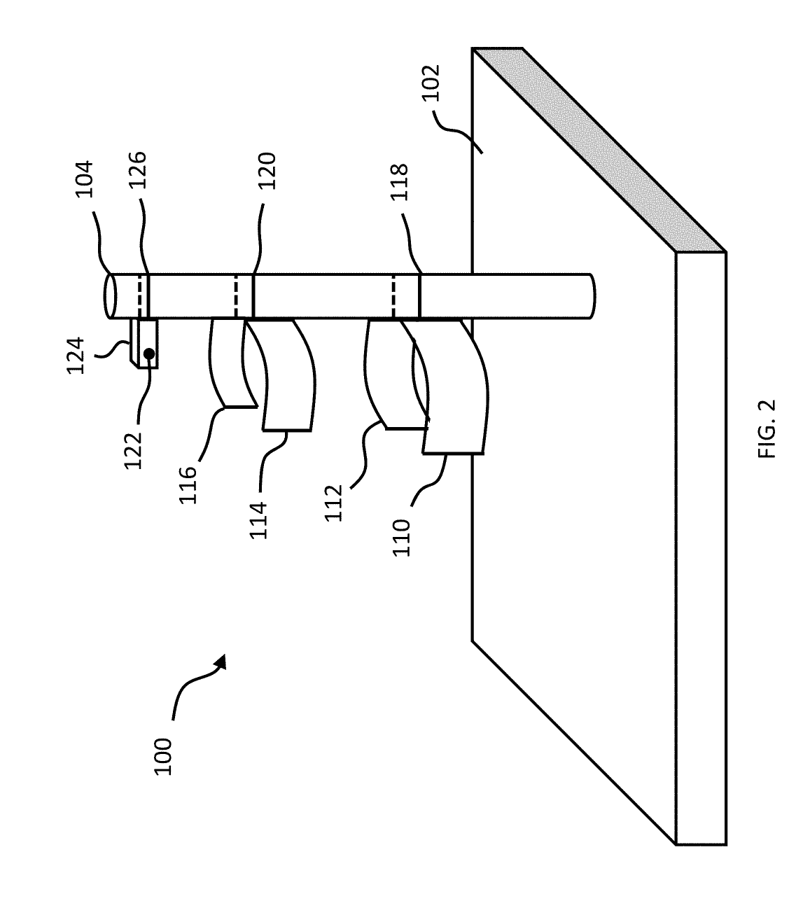

FIG. 2 is another example device for holding a container during filling the container with a liquid, in accordance with an embodiment. As shown in FIG. 2, in some embodiments, the first bracket 106 may include a first arm 110 and a second arm 112 (also referred to herein as arms). Each of the first arm 110 and the second arm 112 may be suitably shaped for receiving a portion of the container. For example, each arm may be curved slightly or circular in shape to receive a cylindrical container and/or bottle therebetween. In some embodiments, the first arm 110 and the second arm 112 may be diametrically adjustable to receive a variety of differently sized containers. The second bracket 108 may also include a first arm 114 and a second arm 116 shaped similar to the arms of the first bracket 106. In some embodiments, the first arm 114 and the second arm 116 of the second bracket 108 are also diametrically adjustable, for example, to receive a neck portion or other portion of the container as desired.

In some embodiments, the first bracket 106 and second bracket 108 are rotatable around the post 104. For example, when filling a larger container, use of the second bracket 108 might not be necessary and/or desired. In such instances, the second bracket 108 could be rotated around the post 104 while not in use. In another example, when filling a smaller container such as a beer bottle, soda bottle, etc., use of the first bracket 106 might not be necessary and/or desired, and the first bracket 106 could be rotated around the post 104 while not in use.

In some embodiments, the first bracket 106 and second bracket 108 (also referred to herein as brackets) are fixed to the post 104 with a first retention member 118 and a second retention member 120, respectively. The first retention member 118 and second retention member 120 (also referred to herein as retention members) may be, for example, bands, wires, ties, clips, clamps, clasps, or other types of fasteners capable of retaining the brackets in place on the post 104. In some embodiments, the first retention member 118 and second retention member 120 may be movable along the length of the post 104 for adjustment of the brackets. For example, the first retention member 118 and second retention member 120 could be temporarily loosened to slide along the length of the post 104 and tightened once in a desired location.

In certain instances, the device 100 also includes a light 122 arranged at a third location along the post 104 and configured to illuminate a portion of the container. As discussed above, illumination of the container may aid the brewer or vintner in determining a stopping point while filling to prevent overflowing the container. In certain instances, the light 122 may be, for example, an LED light.

In certain instances, the light 122 includes a battery pack 124 for powering the light. In certain instances, a battery pack 124 may be beneficial to increase the portability and ease-of-use of the device 100. For example, the device 100 would not require use of an outlet or positioning near the outlet. The battery pack 124 can be attached to the post 104 with a third retention member 126, similar to the retention members described above. In other embodiments, the light 122 may not include a battery pack 124. In such instances, the light 122 may be directly attached to the post 104 with the third retention member 126. In yet other embodiments, the light 122 may be coupled to the post 104 by a bracket and held adjacent a portion of the container by an arm (not shown) extending from the bracket and/or post 104.

In certain instances, the light 122 is adjustable along the length of the post 104, similar to that described above for the first and second brackets 104, 106. Adjustability of the light 122 may be beneficial when filling containers of varying sizes. For example, the light 122 may be closer to the second end 107 of the post 104 when filling a wine bottle and closer to the first end 105 of the post 104 when filling a beer bottle.

The device 100 as described above can be used in a variety of different ways. In one example, a method of using the device 100 includes positioning a beverage container on the base 102 and orienting the beverage container such that it is received by at least one of the first bracket 106 and the second bracket 108. In some embodiments, the first bracket 106 and/or the second bracket 108 may then be tightened or otherwise adjusted to fit the dimensions of the container. In some embodiments, the light 122 may also be adjusted to a height suitable to illuminate the container as desired. Once appropriately positioned, the light 122 is then switched on to illuminate an interior of the container. The beverage container is then filled to a desired level and/or stopping point, as indicated by the light 122. The light 122 is then turned off and the beverage container is removed from the device 100.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A device for holding a container during filling the container with a liquid, the device comprising:
a base having a planar surface for a base of the container to be arranged thereon;
a post extending perpendicular to the base;
a first bracket arranged at a first location along the post and a second bracket arranged at a second location along the post with at least one of the first bracket and the second bracket being configured to interface with and hold the container and during filling of the container; and
a light arranged at a third location along the post and configured to illuminate a portion of the container to assist in determining a filling end point for the liquid within the container.

2. The device of claim 1, wherein one of the first bracket and the second bracket is configured to interface with a beer bottle, and another of the first bracket and the second bracket is configured to interface with a wine bottle.

3. The device of claim 1, wherein the light is configured to adjust to a fourth position along the post.

4. The device of claim 1, wherein the post is removeable from the base.

5. The device of claim 1, wherein the first bracket and the second bracket are configured to rotate about the post.

6. The device of claim 1, wherein the first bracket and the second bracket are configured to friction fit with the container to secure the container.

7. The device of claim 1, wherein the light is coupled to the post by a bracket, and the light is held adjacent the portion of the container by an arm extending from the bracket.

8. A beverage container stabilizing device for disadvantaged individuals, the device comprising:
a base having a first aperture;
a stabilizing member having a first end, a second end, and a length, the first end secured to the base in the first aperture;
a plurality of brackets spaced along the length of the stabilizing member, the plurality of brackets configured to receive at least a portion of the beverage container; and
a light coupled to the second end of the stabilizing member for illuminating an interior at the beverage container.

9. The device of claim 8, wherein the plurality of brackets includes a first bracket located near the first end of the stabilization member and a second bracket located near the second end of the stabilization member.

10. The device of claim 9, wherein the first bracket is larger than the second bracket.

11. The device of claim 8, wherein each bracket of the plurality of brackets includes a first arm and a second arm, the first and second arms being adjustable to fit a diameter of the beverage container.

12. The device of claim 8, wherein the light is adjustable along the length of the stabilizing member.

13. The device of claim 8, wherein the stabilizing member is any one of a dowel, a rod, a shaft, a plank, a beam.

14. The device of claim 8, further comprising a spacer arranged within the aperture for receiving the first end of the stabilizing member.

15. The device of claim 8, wherein the light further includes a battery pack to increase portability of the device.

16. The device of claim 8, wherein the plurality of brackets are configured to friction fit with the beverage container.

17. The device of claim 8, further comprising a plurality of retention members configured to retain the plurality of brackets to the stabilization member.

18. A method of using a beverage container stabilization device, the method comprising:
positioning a beverage container on a base of the device such that the beverage container is received by at least one bracket of the device;
switching on a light associated with the device to illuminate an interior of the beverage container;
filling the beverage container to a desired level as illuminated by the light;
switching off the light; and
removing the beverage container from the base.

19. The method of claim 18, further comprising adjusting the at least one bracket to fit a diameter of the beverage container.

20. The method of claim 18, further comprising adjusting a location of the light along a length of a stabilization member to a desired stopping point.
